(19) United States
(12) Patent Application Publication
(10) Pub. No.: US 2026/0161648 A1
(43) Pub. Date: Jun. 11, 2026

(54) UNIFIED DATA & ANALYTICS SYSTEM AND METHOD USING VIRTUALIZED DATA ACCESS

(71) Applicant: CLARISTA INC., Ridgewood, NJ (US)

(72) Inventor: Suvrat BANSAL, Ridgewood, NJ (US)

(73) Assignee: CLARISTA INC., Ridgewood, NJ (US)

(21) Appl. No.: 18/705,755

(22) PCT Filed: Jan. 20, 2023
(86) PCT No.: PCT/US2023/061013

§ 371 Date: Apr. 29, 2024

Related U.S. Application Data
(60) Provisional application No. 63/301,810, filed on Jan. 21, 2022.

(51) Int. Cl. G06F 16/2453; G06F 16/248

(52) U.S. Cl. CPC G06F 16/24544; G06F 16/248

(57) ABSTRACT

Computer-based data access, integration, management, and presentation are provided. A data processing apparatus connects a computing device to each of a plurality of data sources. A first GUI is accessible to the computing device. The first graphical user interface(s) can display information associated with each of the plurality of data sources and selectable controls for defining a domain. The data processing apparatus can provide the domain and corresponding virtual datasets in accordance with the data definitions, without copying or moving data. A second GUI can be provided for access to the virtual datasets, and an integrated development environment. Furthermore, the data processing apparatus can provide at least one third GUI accessible to each of a plurality of computing devices, in which the third GUI can present the virtual datasets in at least one graphical format.

### CROSS-REFERENCE TO RELATED APPLICATIONS

This application is a U.S. National Stage under 35 U.S.C. § 371 of International Patent Application No. PCT/US2023/061013, filed Jan. 20, 2023, which is based on and claims priority to U.S. Provisional Patent Application Ser. No. 63/301,810, filed on Jan. 21, 2022, the entire contents of each application are hereby incorporated by reference, as if expressly set forth herein.

### FIELD

The present disclosure relates, generally, to data management and, more particularly, to providing self-service analytics using virtualized data access via a single business access layer for access to and processing of disparate data sources and forms of information.

### BACKGROUND

Managing information stored in electronic formats virtually anywhere, but particularly in large enterprises, has been and continues to be daunting. This is at least partly due to data being generated, used, and stored in decentralized environments. As such, creating and/or viewing specific analytical output, such as charts or results of data queries that are based on disparate sources of information (e.g., in the enterprise) can be difficult, if not impossible, for individuals and teams. Access to or use of information that an individual or group needs or desires is often unavailable, for example, for being unlocatable or controlled by departments or individuals that are unable or unwilling to provide access. Even for information that may eventually be accessible, such as in response to requests, such information is not available on demand which can impede production and timely business decisions due to a slow turn around.

FIG. 1 is a block diagram illustrating the complexities and disparate nature of data and processes in the enterprise. These and other complexities are especially troubling for teams (and individuals) requiring access to data in timely and useful ways. As shown in FIG. 1, data can be stored in databases, spreadsheets, on-line providers, or other external or internal sources, such as data lakes and/or data warehouses, which may need to be accessed via one or service providers or managers. Even when the data eventually are made available, business users still have to use various systems to form a complete view of the information. For example, data catalogs for data definitions, data quality measurement systems, data processing via algorithmic and modeling systems (e.g., for advanced analytics), and various visualization tools to analyze data visually can be necessary for a comprehensive view and analysis. The connecting lines shown in FIG. 1 illustrate the complexity in data management in such environments, which results in extended periods of time for frontline teams to get data and causes difficulties in consuming that data using simple business terms.

Further, conventional access to disparate sources of data requires different and complex tools just for providing various insights, and results of such insights are not usually readily sharable. Moreover, data access controls are left to one system at a time, thereby precluding a possibility of prolific access and use.

It is with respect to these and other considerations that the disclosure made herein is presented.

### BRIEF SUMMARY

In one or more implementations of the present disclosure, a computer-implemented system and/or method is provided for data access, integration, management, and presentation. At least one data processing apparatus that is configured by executing instructions stored on processor readable media can provide a connection module that can connect a computing device to each of a plurality of data sources. Further, the at least one data processing apparatus can provide at least one first graphical user interface that is accessible to the computing device. The at least one first graphical user interface can display information associated with each of the plurality of data sources and selectable controls for defining a domain and associates custom data definitions based on at least some of the plurality of data sources, including to restrict access to at least some data in the at least some of the plurality of data sources. Still further, the at least one data processing apparatus can provide a virtualization module, which can provide the domain and corresponding virtual datasets of data from the at least some of the data sources in accordance with each of the custom data definitions, without copying or moving data from any of the plurality of data sources. Moreover, at least one second graphical user interface that is accessible to each of a plurality of computing devices can be provided by the at least one data processing apparatus, in which the at least one second graphical user interface provides access to the virtual datasets associated with the domain, and an integrated development environment. Furthermore, the at least one data processing apparatus can provide at least one third graphical user interface accessible to each of a plurality of computing devices, in which the at least one third graphical user interface can present the virtual datasets in at least one graphical format.

In one or more implementations of the present disclosure, at least one of the at least one second graphical user interface and the at least one third graphical user interface includes a dashboard.

In one or more implementations of the present disclosure, the integrated development environment includes controls for defining queries including selections and joins.

In one or more implementations of the present disclosure, at least one of the at least one first graphical user interface, the virtualization module, and the at least one second graphical user interface provide data security and logging of user activity.

In one or more implementations of the present disclosure, at least one of the connection module and the virtualization module provide performance optimization.

In one or more implementations of the present disclosure, the performance optimization includes at least one of time, computer resources, and labor.

In one or more implementations of the present disclosure, an alert module is provided for defining custom alerts, wherein at least one of the custom alerts is provided in at least one of the second graphical user interface and the at least one third graphical user interface.

In one or more implementations of the present disclosure, at least one of the connection module and the virtualization module publishes the datasets and monitors data quality, business activity, and data-related events associated with the published datasets.

In one or more implementations of the present disclosure, at least two of the at least one first graphical user interface, the at least one second graphical user interface, and the at least one third graphical user interface comprise a single graphical user interface.

In one or more implementations of the present disclosure, the integrated development environment is configured to create at least one new data set from the virtual datasets associated with the domain.

In one or more implementations of the present disclosure, the at least one third graphical user interface presents the virtual datasets and the at least one new data set in at least one graphical format.

In one or more implementations of the present disclosure, further comprising at least one fourth graphical user interface accessible to each of a plurality of computing devices, wherein the at least one fourth graphical user interface provides searching functionality.

In one or more implementations of the present disclosure, wherein the virtualization module includes a meta-data definition layer.

Other features and advantages of the present disclosure will become apparent from the following description, which refers to the accompanying drawings.

### BRIEF DESCRIPTION OF THE DRAWINGS

Aspects of the present disclosure will be more readily appreciated upon review of the detailed description of its various embodiments, described below, when taken in conjunction with the accompanying drawings, of which:

FIG. 1 is a block diagram illustrating complexities and the disparate nature of data and processes in the enterprise;

FIG. 2 is a block diagram illustrating an example arrangement in accordance with virtualized data access in accordance with an example implementation of the present disclosure;

FIG. 3 illustrates a block diagram that includes publishing and security, as well as data use/analytics, in accordance with an example implementation;

FIG. 4. is a block diagram illustrating an example implementation of the present disclosure, including virtualized data access and modules associated with FIG. 3;

FIG. 5 illustrates an example display screen that identifies a respective domain and a plurality of data resources or datasets, in accordance with an example implementation of the present disclosure;

FIG. 6 illustrates an example display screen that identifies various summary option sections, in accordance with one or more implementations of the present disclosure;

FIG. 7 illustrates an example display screen, including graphical representations of data identified in a data dictionary details section of FIG. 6,

FIG. 8 illustrates an example display screen illustrating a preview option and a data preview section for a respective data pod, in accordance with one or more implementations of the present disclosure;

FIG. 9 illustrates an example data preview section including selection of show/hide data attributes control, in accordance with one or more implementations of the present disclosure;

FIG. 10 illustrates an example display screen providing graphic representations associated with data analysis, in accordance with one or more implementations of the present disclosure;

FIG. 11 illustrates an example display screen including filter options for data based on one or more conditions, in accordance with one or more implementations of the present disclosure;

FIG. 12 illustrates example analytics options that can be provided to include options for a dashboard view, visual charts, and data queries, in accordance with one or more implementations of the present disclosure;

FIG. 13 illustrates a portfolio analysis overview that is associated with many data pods, in accordance with one or more implementations of the present disclosure;

FIG. 14 illustrates analysis section that can be provided, including various analysis summaries and representations associated with a respective data pod, in accordance with one or more implementations of the present disclosure;

FIG. 15 illustrates an example display screen including features, such as data and graph options, pie chart, and underlying data, in accordance with one or more implementations of the present disclosure;

FIG. 16 illustrates an integrated development environment provided in response to data and graph options, in accordance with one or more implementations of the present disclosure;

FIG. 17 illustrates an example display screen including additional integrated development environment options and data results, in accordance with one or more implementations of the present disclosure;

FIG. 18 illustrates an example display screen provided for identifying alerts in connection with respective data pods, in accordance with one or more implementations of the present disclosure;

FIG. 19 illustrates an example display screen that includes sections for defining data flows and results thereof, in accordance with one or more implementations of the present disclosure;

FIG. 20 illustrates one or more scheduler options that can be configured to execute alerts, flows or a combination thereof, in accordance with one or more implementations of the present disclosure;

FIG. 21 illustrates example details that can be associated with a respective scheduler option, in accordance with one or more implementations of the present disclosure;

FIG. 22 illustrates an example display screen showing configuration options of several steps that can be assigned in a single scheduler, in accordance with one or more implementations of the present disclosure;

FIG. 23 illustrates an example display screen showing monitoring capabilities in accordance with an example implementation of the present disclosure;

FIG. 24 illustrates example data connections that can be selected for defining workspaces for data management, in accordance with one or more implementations of the present disclosure;

FIG. 25 illustrates an example display screen including a section for defining a data pod name, a data domain, and providing a general description, in accordance with one or more implementations of the present disclosure;

FIG. 26 illustrates an example display screen associated with the present disclosure that includes a graphical user interface for a query editor and query results, in accordance with one or more implementations of the present disclosure;

FIG. 27 illustrates an example display screen including a graphical representation of a ‘Lineage’ option 2702, and identifies data pods 504 that can be merged and usable in respective data catalogs, in accordance with one or more implementations of the present disclosure;

FIGS. 28-29 illustrate an example graphical representations in connection with “Access” options 606 for a Data POD 504 “investor_data,” for a data domain and includes options for access control policy details and data column/field masking options, in accordance with one or more implementations of the present disclosure;

FIG. 30 illustrates a data dictionary module, a meta-data repository of business data categories and associated business data terms with additional details such as description, data owner, data steward and classifications, in accordance with one or more implementations of the present disclosure;

FIG. 31 illustrates an example display screen showing details that can be associated with a data associated with a respective data dictionary, in accordance with one or more implementations of the present disclosure;

FIG. 32 is a diagram of an example hardware arrangement that operates for providing the systems and methods disclosed herein; and

FIG. 33 illustrates, in block diagram form, an exemplary data processing apparatus and/or user computing device that can provide functionality in accordance with the teachings herein.

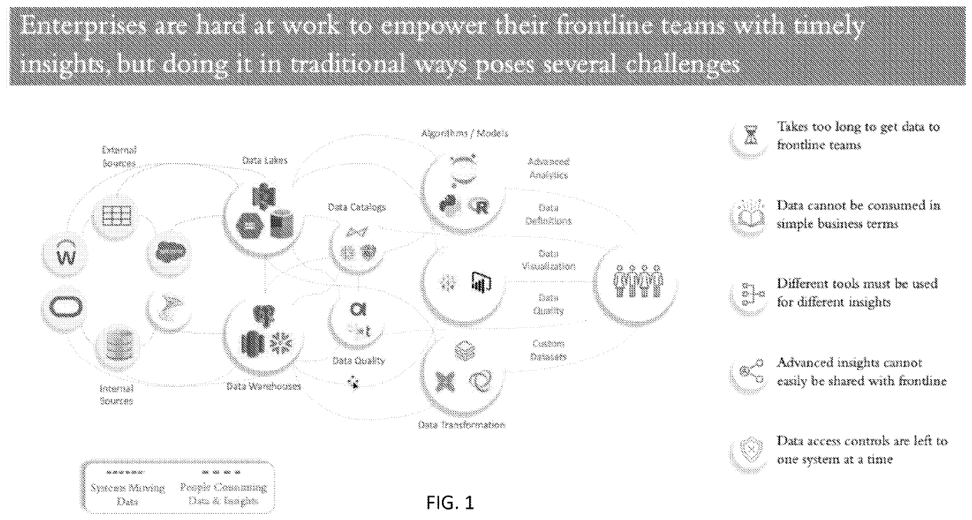

### DETAILED DESCRIPTION

By way of overview and introduction, the present disclosure improves upon frontline data access and self-service analytics, including by providing ease of use. In one or more implementations of the present disclosure, data that are provided for user access and use are not copied or moved from locations where the data are otherwise stored and managed. Instead, data are left undisturbed and published via a single business access layer to provide an interactive and widespread virtualized data access.

In accordance with the teachings herein, data can be identified as a function of data definitions that can be defined and updated by users in one or more interactive graphical display screens. Data definitions can be provided in various formats, e.g., fields, and technical definitions of data sets can be provided for access to respective data for operations thereon. For example, a technical definition can include, but is not limited to, one or more queries that can be provided in the structured query language (“SQL”) for data joins, selections, filters, or the like. In addition, business data definitions can be provided by users that identify one or more data sources that are usable for users to select and operate on data. Such definitions can include a plurality of data sources, definitions, locations, or other characteristics, without disturbing or even knowing respective data characteristics. The present disclosure provides for a single business definition, which can be selected by a user, e.g., via virtualized data access, and the user can access and process data that are associated with that respective business definition automatically and immediately. Users are no longer confused with technicalities of where data are located, structured, or the like, and the present disclosure provides a simple business defined data set that can be used to provide on-demand access to data.

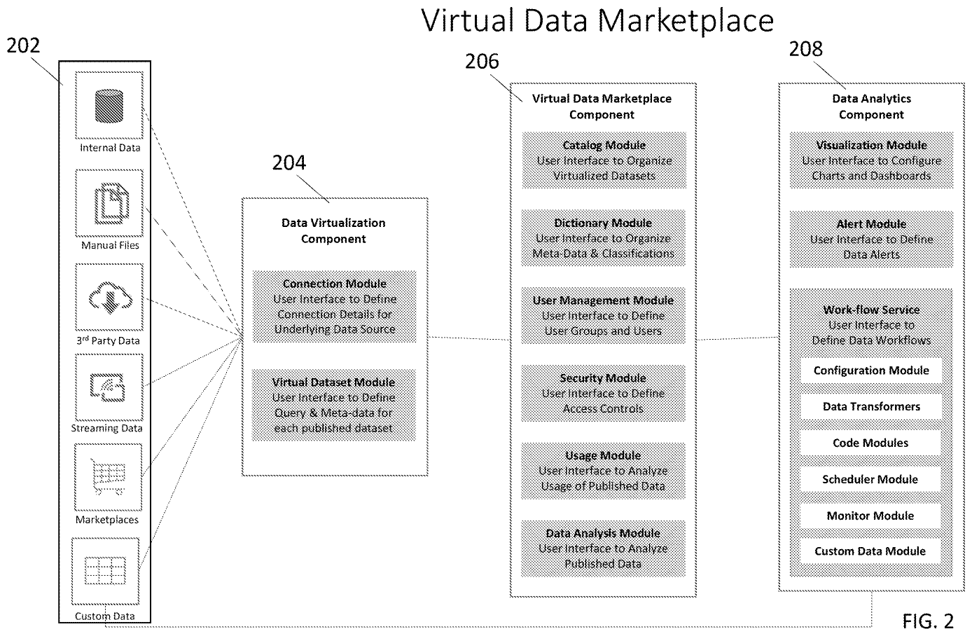

FIG. 2 is a block diagram illustrating an example arrangement in accordance with virtualized data access, in accordance with the present disclosure. Data sources 202, including (but not limited to) internal data, manual files, 3^{rd} party data, streaming data, marketplaces, and custom data. Data sources 202 can be accessed via one or more data virtualization components 204, which can include a connection module (including a user interface to define connection details for underlying data source(s)) and a virtualized dataset module (including a user interface (“U/I”) to define query and meta-data for each published dataset). Moreover, a visual data access component 206 can be provided, which can include a catalog module (including a U/I User to organize virtualized datasets), a dictionary module (including U/I to define and organize data attributes), a user management module (including a U/I to define user groups and users), a security module (including a U/I to define access controls), a usage module (including a U/I to analyze usage of published data), and a data analysis module (including a U/I to analyze published data.) Further, a data analytics component 208 can be provided, which can include a visualization module (including a U/I to configure charts and dashboards), an alert module (including a U/I to define data alerts), a work-flow service module (including a U/I to define data workflows), as well as a configuration module, data transformers, code modules, a scheduler module, a monitor module, and a custom data module, each of which can include one or more graphical user interfaces.

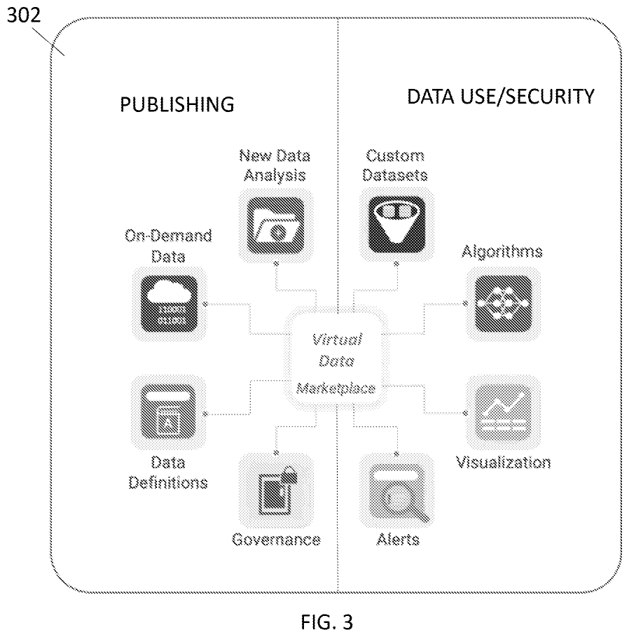

FIG. 3 illustrates a block diagram that includes virtualized data access that can include one or more of publishing and data use modules 302, including new data analysis, on-demand data, data definitions, and governance. Further, virtualized data access in accordance with the present disclosure can be provided to include custom datasets, algorithms, data visualization options, and alerts. Details regarding these and other features of the present disclosure are shown and described herein.

Furthermore, the present disclosure applies levels of security and access control to ensure the integrity and safety of data sources. For example, published data sets can be published in groups as domains, which can represent descriptive functions (e.g., “Risk Finance Sales”) as well as purpose (“Client 360 Datasets”). Thereafter, users and/or user groups can be attached to the domains (or specific datasets within a domain). Further, dynamic security can be provided by the present disclosure, such as to respective areas or elements of the data, for restricting access or sharing of data and access can be restricted to respective user groups or individual users.

In one or more implementations, data can be accessed in an on-demand fashion, including through virtualized data access, from virtually any source. Moreover, users are provided tools to on-board and analyze data that would have otherwise been unavailable to them in conventional practice. Data can be presented with custom business definitions made by users, thereby enabling users to find and access data quickly and conveniently via one or more data catalogs. In one or more implementations, business to technical data translations can be handled automatically, substantially without user actions, thereby eliminating a need for identifying complex technical details regarding locations, types, structures, and other aspects of data. Further, the present disclosure provides for self-service analytics, including qualitative and quantitative analytics, which can be provided via graphical user interfaces (e.g., dashboards) and quantitative insights. Moreover, role-based dynamic data security and data quality, including provisioning and alerts can be provided, as can tracking of data dependencies and usage.

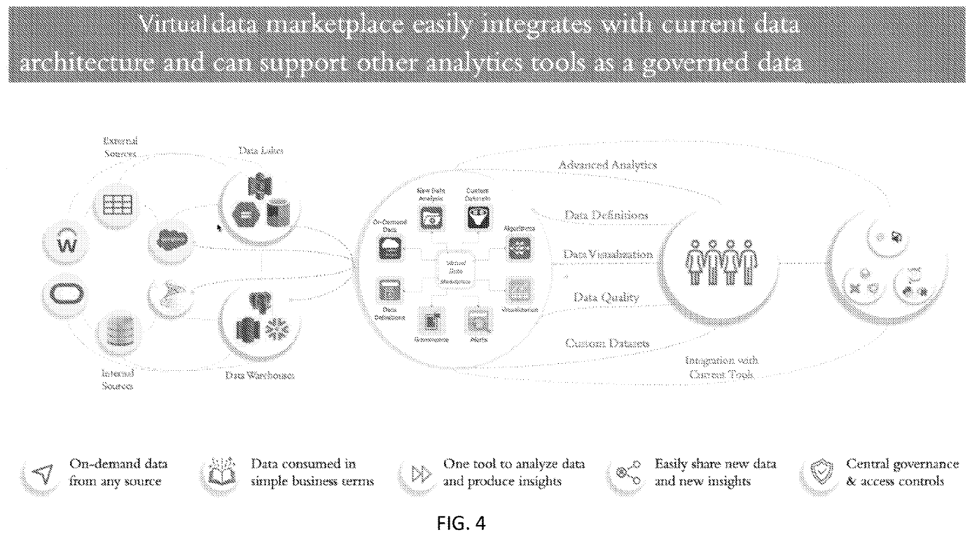

Thus, disparate and remote data sources can be accessed, without data movement or copying, securely and for virtually any use. Users can, for example, provide advanced analytics using models, including to identify meanings of data via data definitions, assess quality through an alert engine, and users can create or derive data sets (e.g., via a custom create dataset engine). Furthermore, existing technologies, such as described above including, but not limited to, data visualization (e.g., tableau, MS-BI), data transformation (e.g., Databricks, DBT, Trifecta), programming languages (e.g., Jupiter, python, R), can be applied simply by identifying data sources as defined in accordance with the present disclosure. The technology shown and described herein precludes the need to identify specific locations where data are “actually” stored, thereby improving functioning of computing tech. This provides an improved access control that is more efficient, faster, and more secure (including, given the user groups that now have access to data in an on-demand platform that was otherwise not available). FIG. 4. is a block diagram illustrating an example implementation of the present disclosure, including virtualized data access and modules illustrated in FIG. 3.

Moreover, the present disclosure improves data discovery by providing data and analytics driven of single business-defined data access layer, as opposed to disconnected and esoteric data catalogs and access tools. Data availability is improved by providing on-demand access from virtually any data source, as opposed to requiring local copying of data for analytics. In accordance with the present disclosure, data analytics can be provided via connected capabilities with a single source of data, as opposed to different tools requiring different capabilities, such as algorithms, data preparation, visual analysis (e.g., charts), or the like. For the enterprise, then, the time to market can be reduced from days/weeks to seconds/minutes and data governance is improved as a function of dynamic role-based access, configurable quality rules, and automated data traceability.

Accordingly, in one or more implementations of the present disclosure, systems and methods are provided for self-service analytics using a virtualized data access layer. An example method can include creating or viewing a specific analytical output such as a chart, data query using one or many virtualized datasets can be published to produce a chart, virtualization module to source, transform and process the data from one or many underlying data sources mapped to the virtualized datasets, applying data access controls defined in the security module, and logging the usage of data in the usage module.

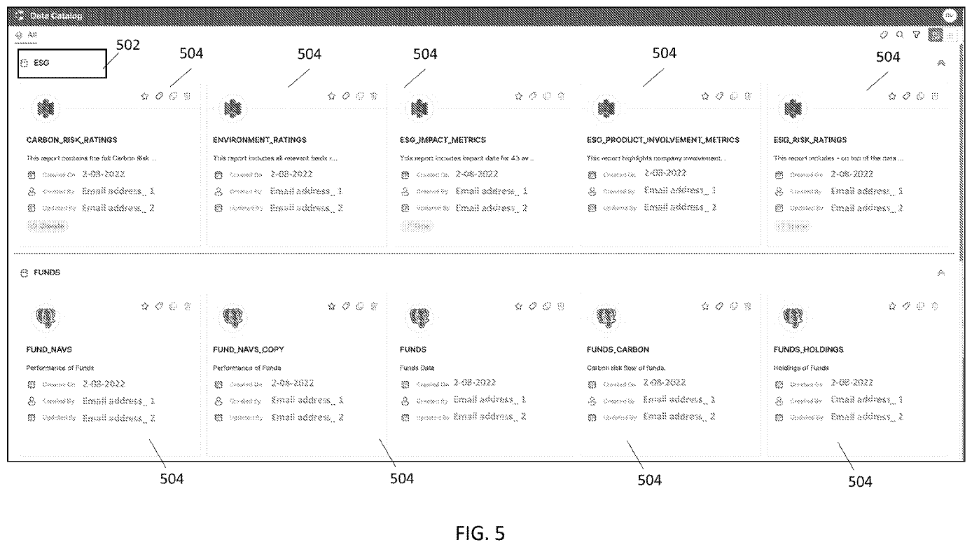

FIGS. 5-31 are example display screens that are provided in accordance with one or more implementations of the present disclosure.

FIG. 5 illustrates an example display screen that identifies a respective domain 502 “ESG” that includes a plurality of data resources or datasets 504, referred to herein, generally, as “data pods.” In the example shown in FIG. 5, the data pods 504 include “CARBON_RISK_RATINGS,” “ENVIRONMENT_RATINGS,” “ESG_MPACT_METRICS,” “ESG_PRODUCT_INVOLVEMENT_METRICS” AND “ESG_RISK_RATINGS.” As shown and described herein, data pods 504 can be constructs of the present disclosure, including data sources (e.g., databases, spreadsheets), query results, custom data (e.g., combinations of data sources), or the like.

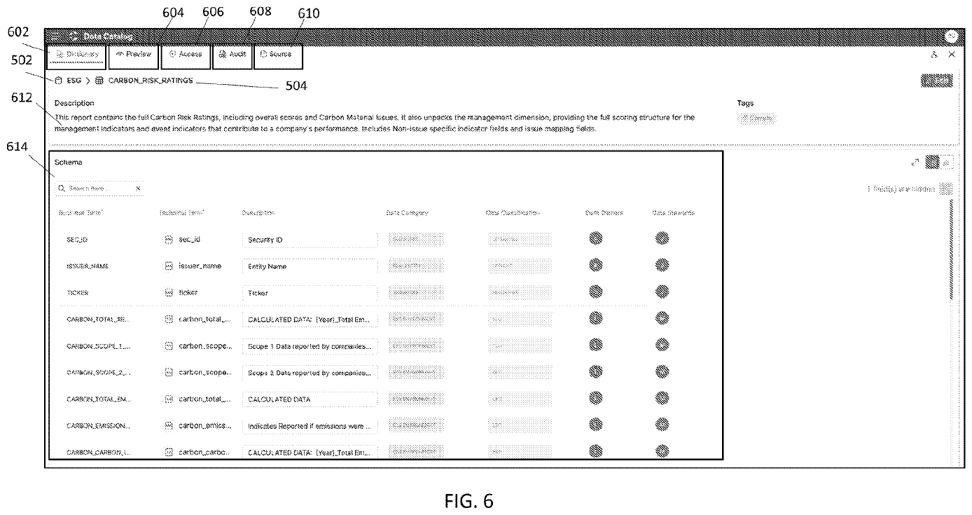

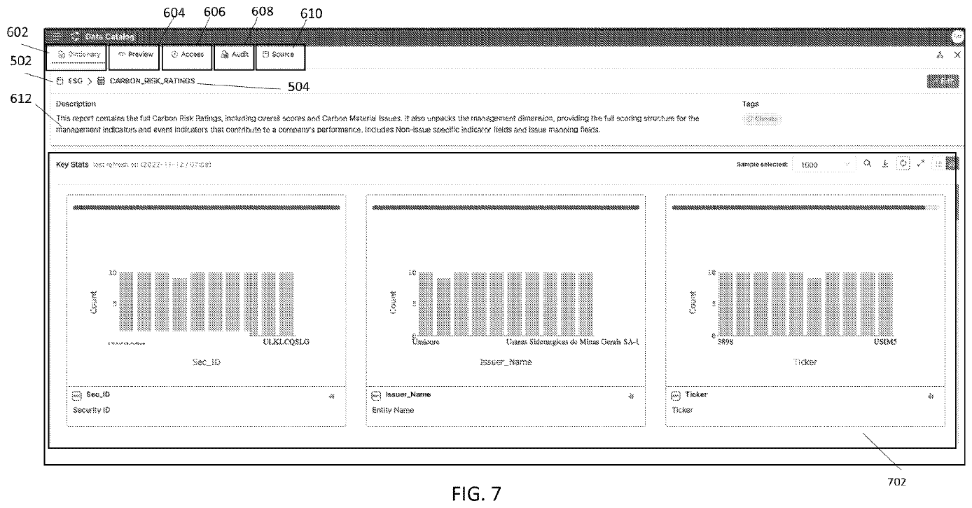

FIG. 6 illustrates an example display screen that identifies various summary option sections, including data dictionary 602, preview 604, access 606, audit 608, and source 610, in connection with respective data pod 504 (“CARBON_RISK_RATING”), which is associated with the domain 502 (“ESG”). The example illustrated in FIG. 6 is associated with ‘Dictionary’ option 602. Data dictionary section 612 provides a business description for the data pod 504 and section 614 provides additional relevant details such as respective business terms, technical terms, descriptions, data category, data classification, data owners and data stewards in accordance with aspects of the selected data pod 504 (e.g.,“CARBON_RISK_RATING”). In addition to providing options for data table layout previews, data dictionary section 604 can provide other views of data, such as statistic summaries section 702 (FIG. 7), which can include graphical representations of data for each of the respective columns identified in data dictionary details section 614.

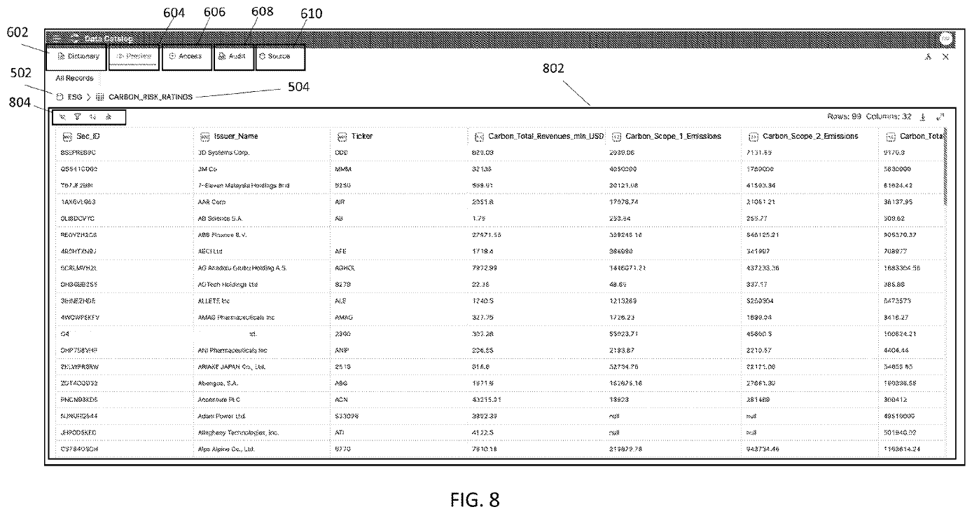

FIG. 8 illustrates display screen in accordance with preview option 604 and provides a data preview section 802 for the respective data pod 504. In addition to displaying data, handling options can be provided via section 802. For example, data can be provided in a table layout in data preview section 802, and a user can be provided with command options 804, such as to show/hide data attributes, filter data, sort in ascending order or sort in descending order, and analyze key statistics for a specific data attribute, or for other optional purposes.

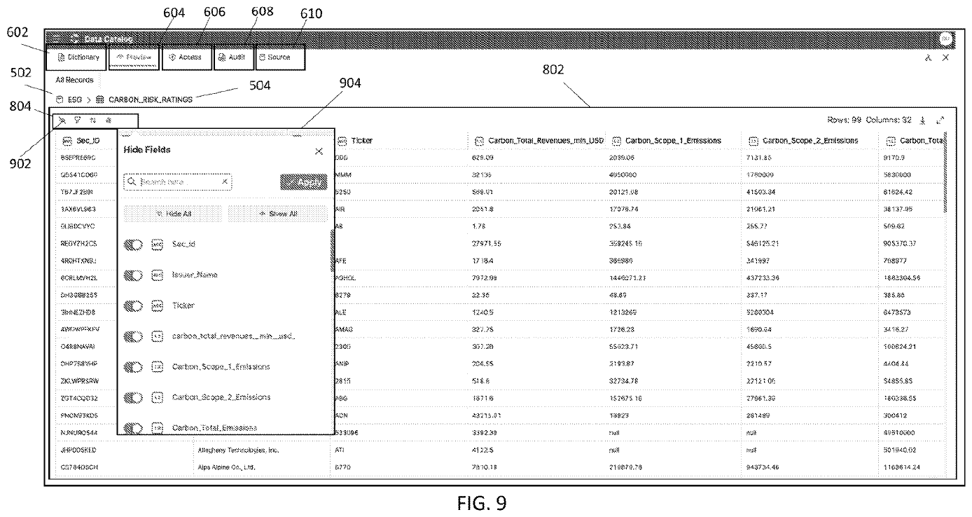

FIG. 9 illustrates an example data preview section 802 in which show/hide data attributes control 902 has been selected in command options 804, thereby resulting in control over respective columns to be shown or hidden in section 802. In the example shown in FIG. 9, hide fields section 904 is displayed in response to selection of control 902, wherein switches (or other interactive graphical controls) are provided for a user to select or deselect field labels, resulting in respective columns of data to appear or disappear in section 802. Other options enable a user to hide all fields (thereby clearing the way for selection of one or just a few fields) or show all fields (thereby clearing the way for deselection of one or just a few fields).

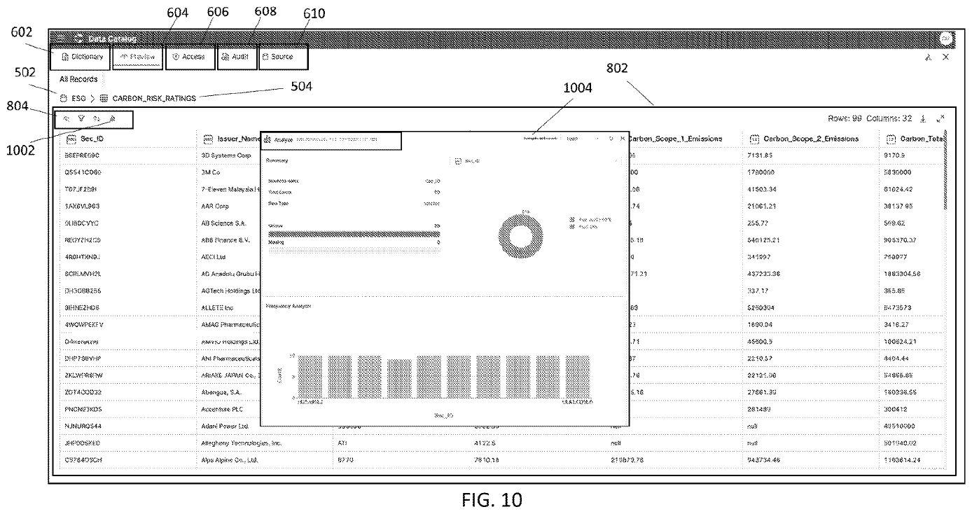

FIG. 10 illustrates an example display screen in response to analyze option 1002 being selected from command options 804, that includes graphic representations section 1004. As shown in section 1004, data representations such as summary, frequency analysis, or the like associated with the respectively selected data pod 504 can be provided to the user.

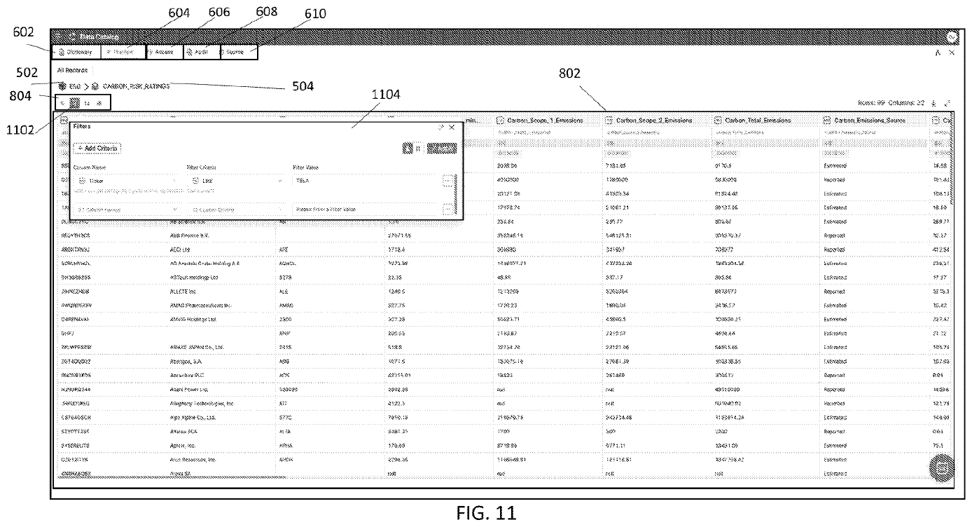

FIG. 11 illustrates an example display screen in response to the filter options 1102 being selected from command options 804, which enables options for the user to filter data based on one or more conditions, and for resulting data to be displayed in data preview section 802. Upon selection of filter options 1102, interactive graphical dialog box 1104 is presented, which includes graphical screen controls containing filtering options, such as by column name, criteria, and value, as well as options for data searching, which can be provided refined filtering processes.

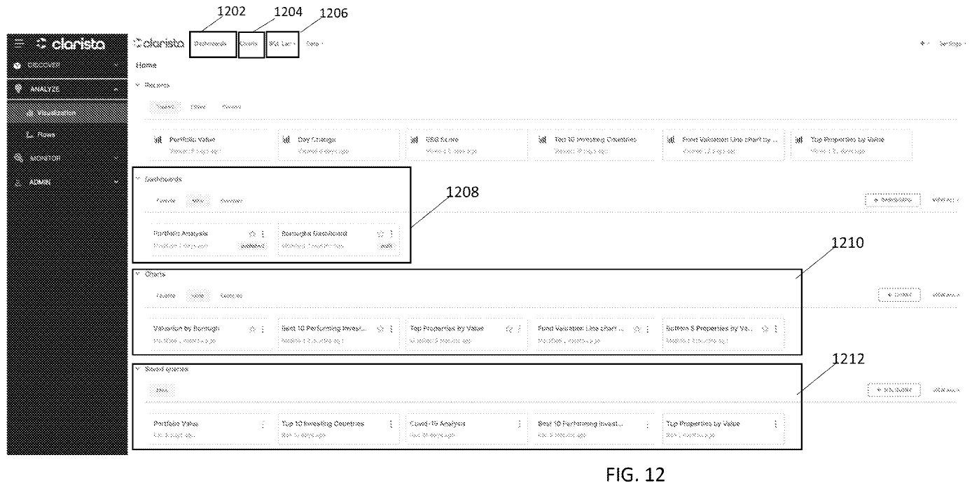

FIG. 12 illustrates example analytics options that can be provided to include options for a dashboard view 1202, charts 1204, and data queries 1206. The examples shown in FIG. 12 shows dashboard options 1208 for 1202, charts options 1210 for 1204 and saved data queries options 1212 for 1206. One or more of these options can be selected for enlargement and additional views of information associated with the respective analytics option.

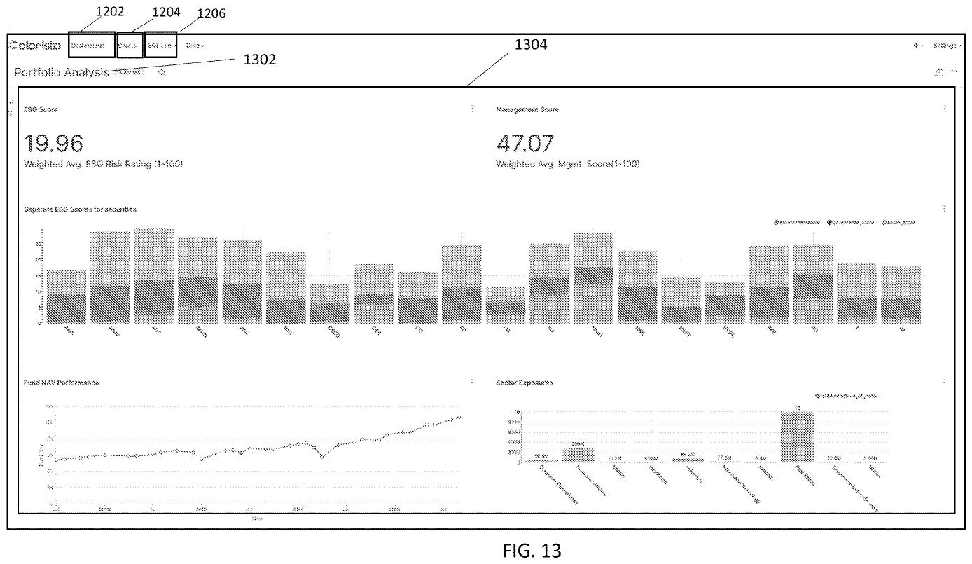

In the example shown in FIG. 13, a respective portfolio analysis overview as an example of 1202, that is associated with many data pods 504 are provided, including, for example, ESG score, management score, separate ESG scores for securities, fund NAV performance, sector exposure, and graphical representations thereof.

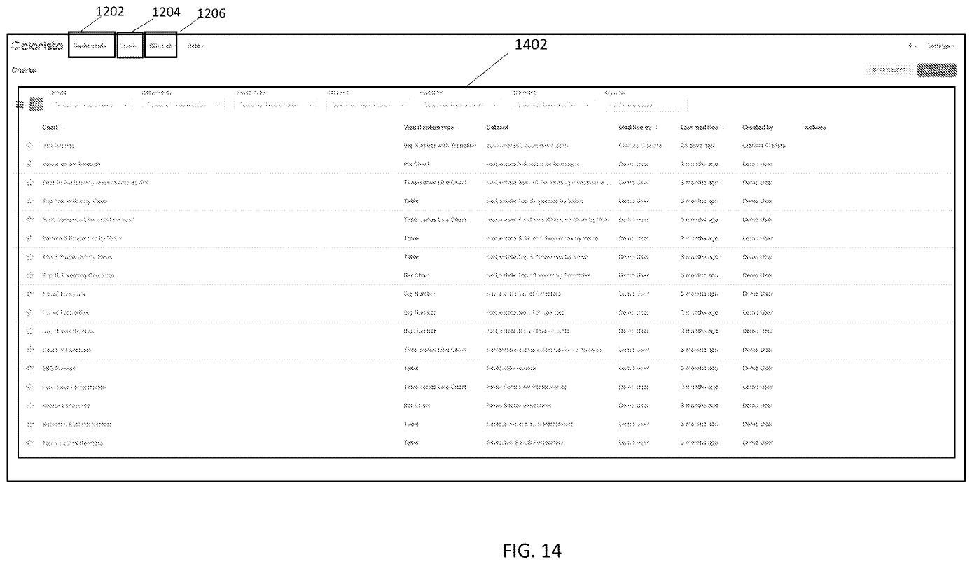

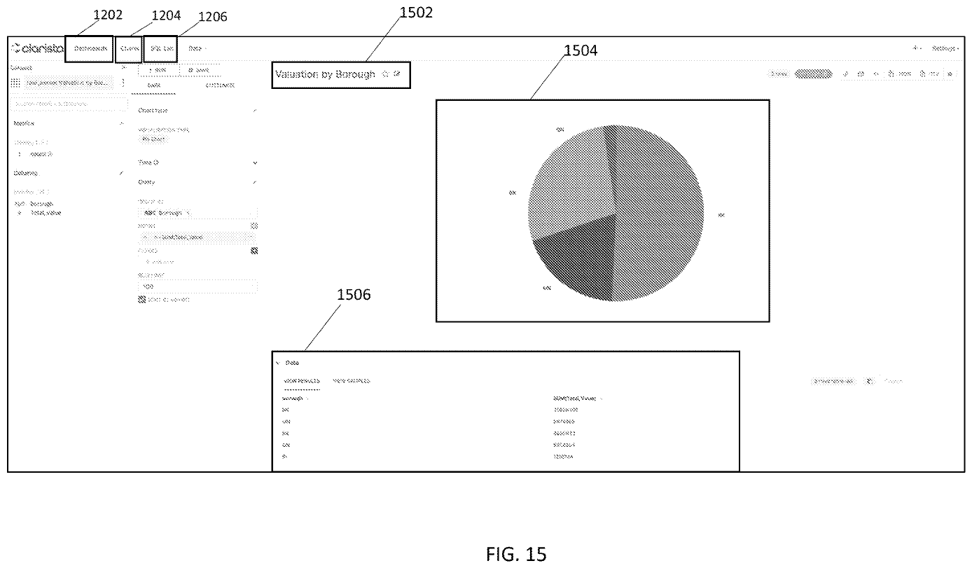

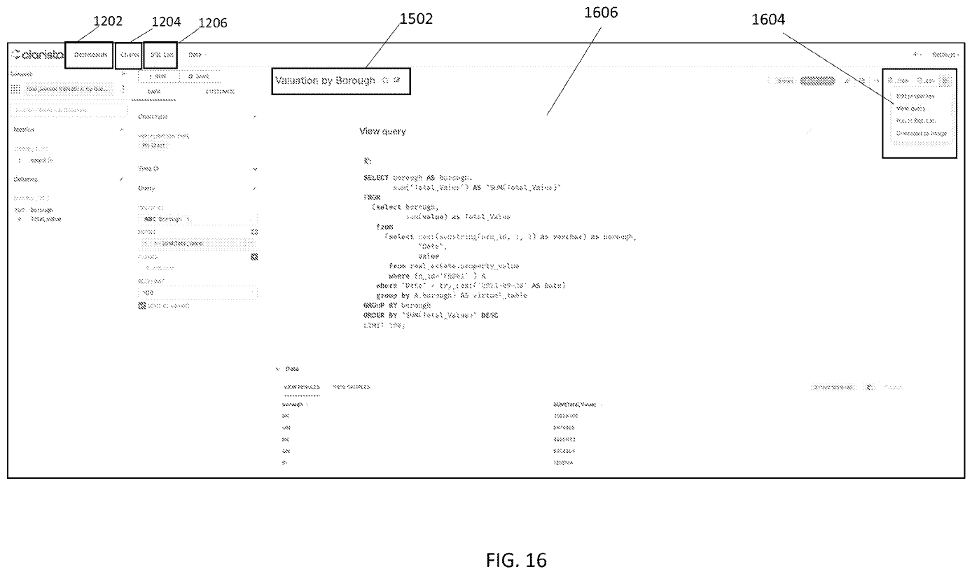

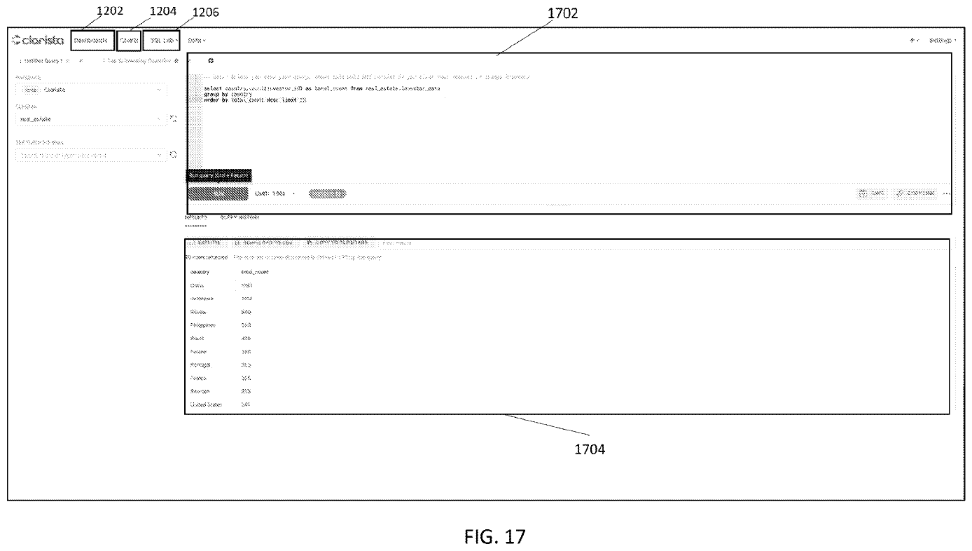

FIG. 14 illustrates analysis section 1402 that can be provided in response to option 1204 being selected and provides various analysis summaries and representations associated with one of many data pods 504. One or more of summaries or representations in section 1402 can be selected for enlargement and additional views of information associated with the respective charts 1402, such as shown in FIG. 15. In the example shown in FIG. 15, chart “Valuation by Borough” option 1502 has been selected and a corresponding graphic progression 1504 and underlying data 1506 associated with the respective chart option are provided. In the example shown in FIG. 16, query options 1604 has been selected and the query of chart 1504 is revealed and can be edited, for example in an integrated development environment (“IDE”). In accordance with one or more implementations of the present disclosure, and IDE can be provided in one or more display screens in various contexts for users to create or edit programming. As changes to a respective query are made, updates can be provided instantly, such as to display new or changed data. FIG. 17 illustrates IDE section 1702 and query results section 1704.

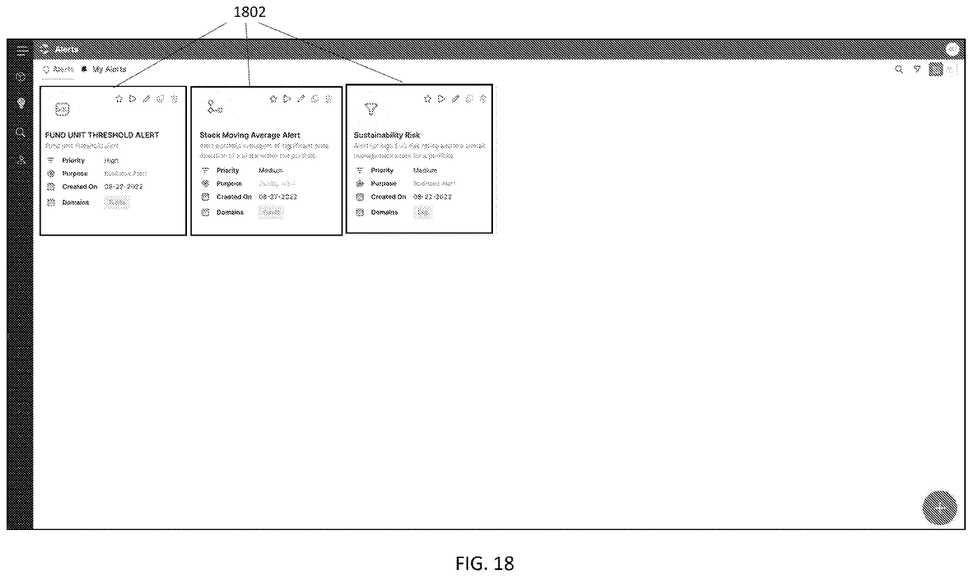

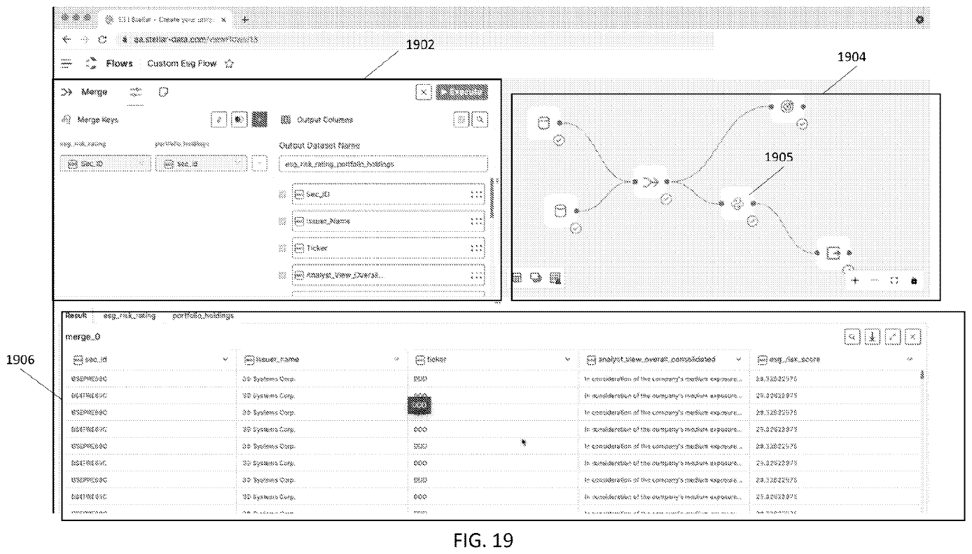

FIG. 18 illustrates display screen that is provided identifying alerts in connection with respective data pods 504. In the example shown in FIG. 18, alert sections 1802 provide alert names, descriptions, priorities, purposes, and alerts creation dates. Options are also provided to highlight a respective alert, edit an alert, delete and alert, or carry out some other desired function. In one or more implementations, alerts can leverage quantitative methods, machine learning, or natural language processing models through one or more flows, such as shown in FIG. 19. Alerts with Condition Type of “Flow Condition” provide for advanced data quality checks, such as text matching and anomaly detection, promptly and across various communication channels.

As will be evident to one of ordinary skill, the present disclosure provides significant flexibility with regard to providing access to disparate and remotely located data sources and enabling users to process data stored therein as a function of custom data dictionaries and catalogs via a convenient set of user interfaces. FIG. 19 illustrates example display screen that includes sections for defining data flows and results thereof. For example, merge section 1902 illustrates options for defining custom merge keys and output columns with regard to one or more respective data pods 504. Graphic section 1904 illustrates active graphic controls that can be used to select and combine (e.g., merge) data sources and to process data associated therewith, for example, for analytics and production. The options provided in FIG. 19 can be used to generate new data sources and data definitions, as well as to act on data that resides across various databases and other sources in the enterprise. Summary section 1906 illustrates results of merge options of sections 1902 and 1904. In addition, programming option 1905 enables users to apply custom or complex calculations to data using various programming languages, such as PYTHON, R, PYSPARK, SCALA or SQL, and unique new data attributes can be created. Such applications can also include the use of Natural Language Processing and Machine Learning models for advanced insights.

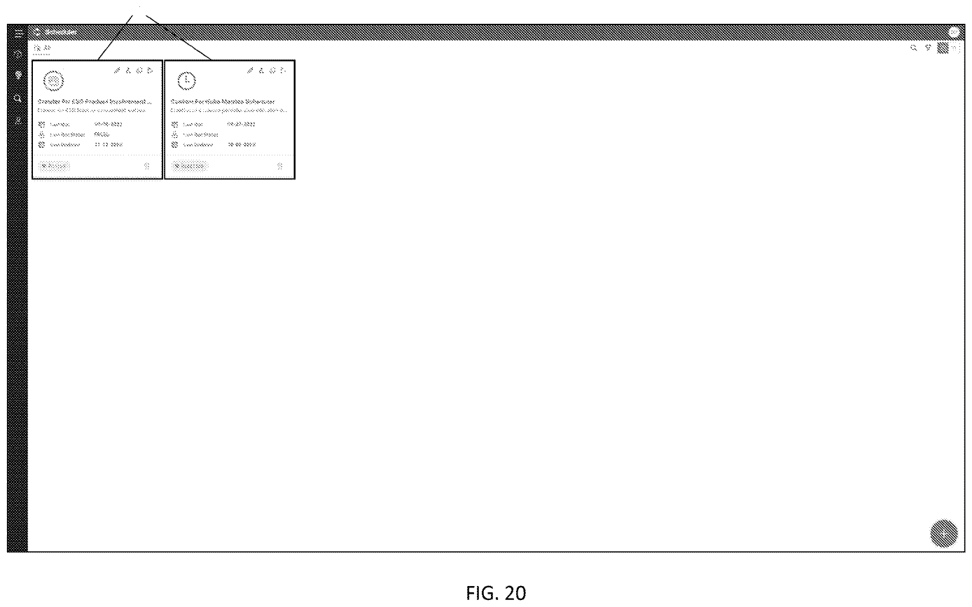

Continuing with the reference to FIGS. 18-19, the present disclosure enables the scheduling, automation and monitoring of Alerts and Data Flows using scheduler functionality shown in FIGS. 20-23. FIG. 20 illustrates one or more scheduler options 2002, that can be configured to execute alerts, flows, or a combination thereof, including on a regular basis based on a day-/time-based schedule or based on a specific change in the underlying data of any data pod 504 or a combination of data pods 504.

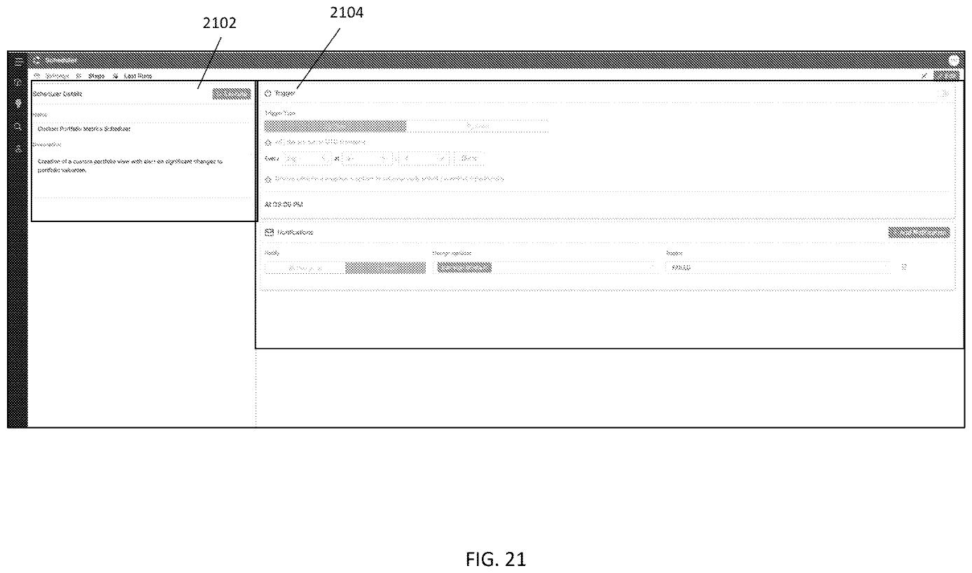

FIG. 21 illustrates an example of the details that can be associated with a respective scheduler option 2002. Scheduler details 2102, for example, include options for a user to assign a name and description to a respective scheduler option 2002, such as to describe its purpose. Trigger section 2104 provides options for a user to define a type of trigger, timeframes for execution, and to define individuals and/or groups to receive notifications. Specifications provided via options shown in FIG. 21 can be time-based or event-based, and further include specifications for notifications that can be used to notify a registered User or User Group of the status of the scheduler 2002.

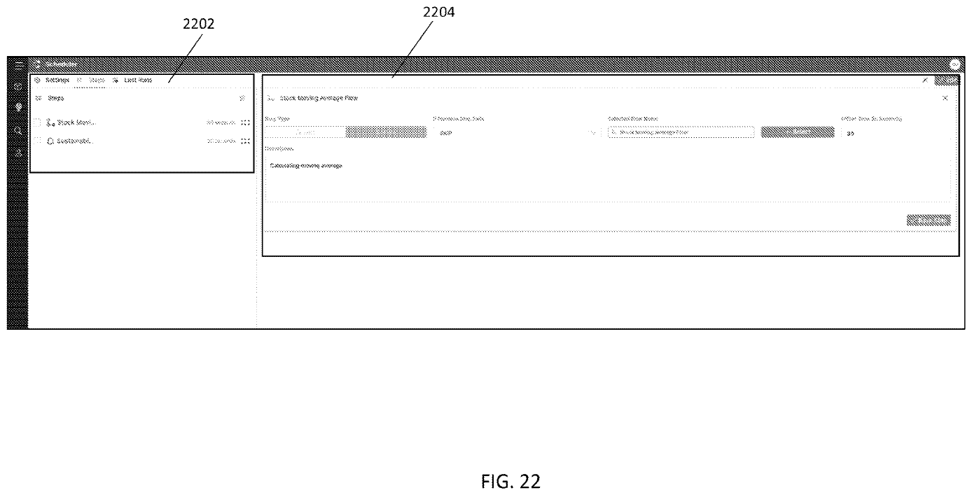

FIG. 22 illustrates an example display screen showing configuration options of several steps that can be assigned in a single scheduler. These steps can include alerts and flows, such as provided in options section 2202, as well as respective details associated with each step, such as provided in options section 2204. Execution of each step within a scheduler option 2002 can be triggered, for example, based on the status of a previous step. In this way, a sequence of operations is provided herein via an interactive and informative graphical user interface.

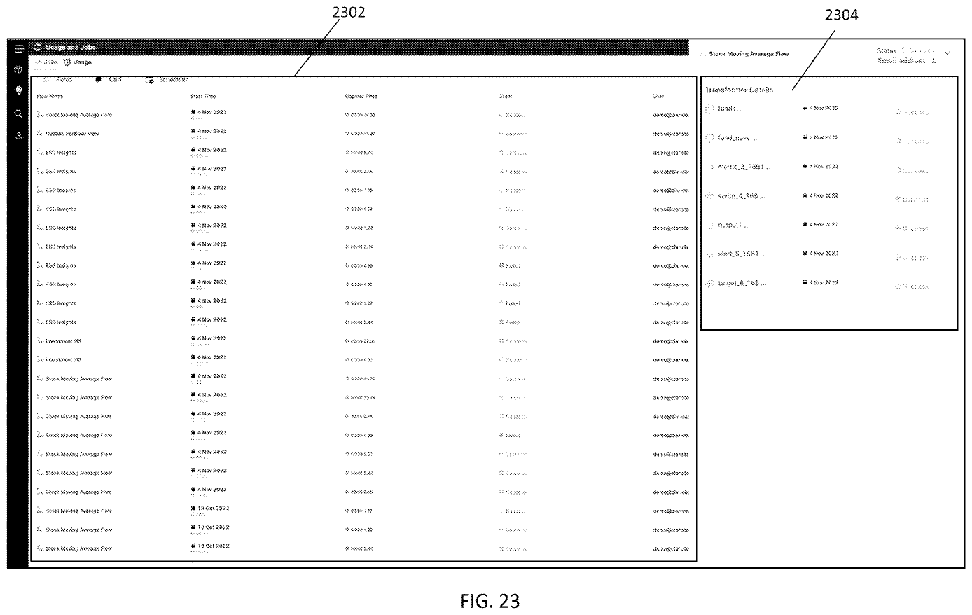

FIG. 23 illustrates an example display screen showing monitoring capabilities in accordance with an example implementation of the present disclosure. After a user or scheduler option 2002 executes an alert or flow, activities can be logged, such as illustrated in summary section 2302. In the example shown in FIG. 23, additional details regarding respective steps of a flow can be shown in details section 2304.

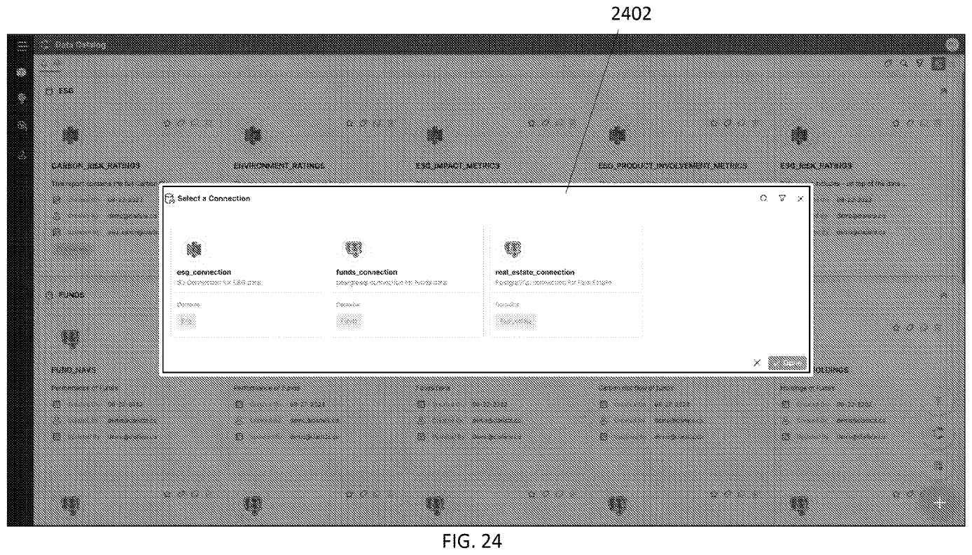

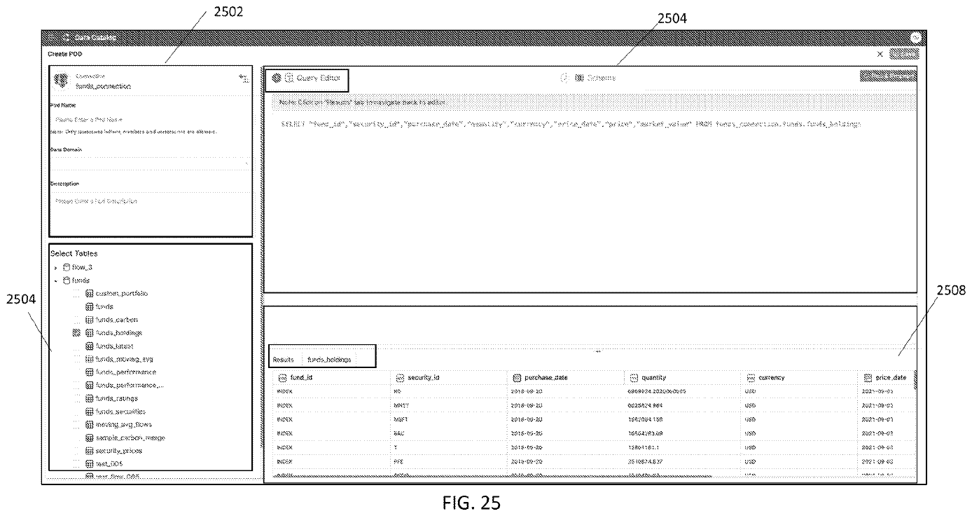

Additional examples with regard to customizing data flows and creating custom data pods 504 in accordance with one or more implementations of the present disclosure are shown in FIGS. 24-26. FIG. 24 illustrates example data connections 2402 that can be selected for connection options that can be used to defining workspaces for data management. In the example shown in FIG. 24, three data connections 2402 are available for selection. FIG. 25 illustrates section 2502 defining a pod name, a data domain, and providing a general description. Any tables that are selected in section 2504 can be added to the newly created pod 504. In section 2504, for example, users are not limited to just a single database table to represent a data pod. Multiple tables can be joined from different database schemas, as shown in section 2504, to create a custom data view, selecting data fields from multiple database table, joining database tables, applying filters, or performing other data tasks.

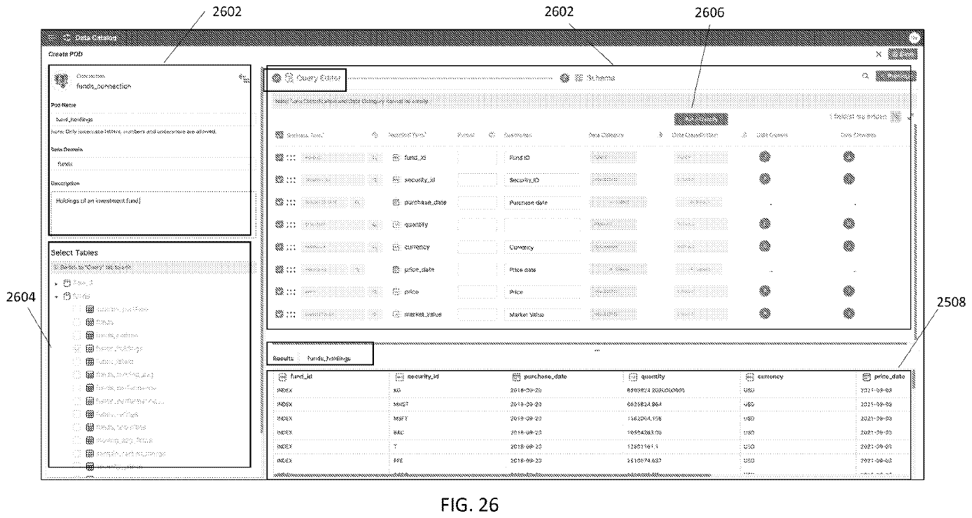

Continuing with reference to FIGS. 24-26, query/schema option section 2504 can be provided, which includes an option to define or edit a query via an IDE (FIG. 25) or and/or edit a schema associated with the new data pod 504 (FIG. 26). Furthermore, results section 2508 can be provided, which includes a table layout identifying columns and rows of respective data in accordance with the newly created pod 504. The columns and section 2508 can be represented in the query/schema section 2602 (FIG. 26) and corresponding to respective business terms, technical terms, types, classifications and descriptions, such as included in select tables section 2604. Users can have significant flexibility to provide business definitions for each data attribute, instead of using just the underlying data store's technical terms. Auto-Classify option 2606 can be used, for example, to classify each data column based on pre-trained machine learning and/or artificial intelligence techniques. These classifications further help in identifying and protecting sensitive information such as personally identifying information (PII), and assist the user in identifying similar data fields/columns based on the content of such fields even when they are named differently in different technical systems. These business terms effectively become the new data schema for published PODs, thereby making it easy for users to find, understand, and use the data for analysis.

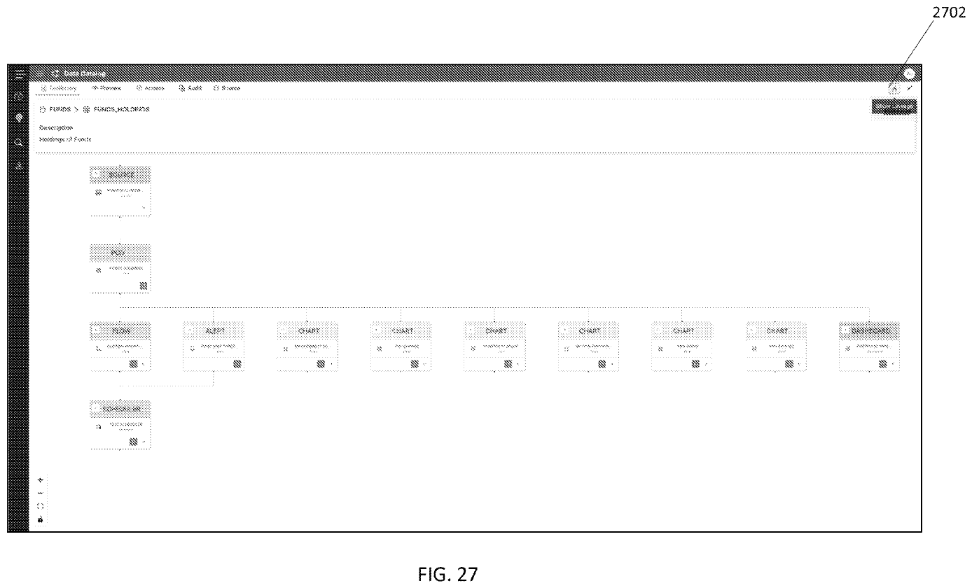

FIG. 27 illustrates an example graphical representation in connection with lineage option 2702, and identifies data pods 504 that can be merged and usable for respective data catalogs. In the example shown in FIG. 27, the merged data pod “FUNDS_HOLDINGS” is sourced from “Portfolio Initial” and usable in connection with flows, alerts, charts, dashboards and scheduler. One Flow is included for “Custom Portfolio Metrics,” one Alert is included for “Fund Unit Threshold,” six Charts are included for “Management Score,” “Day Change,” Portfolio Value,” Sector Exposure,” ESG Score,” and “ESG Rating,” one dashboard is included for “Portfolio Analysis” and one Scheduler is included for “Test Scheduler.” This graphical representation can be auto-generated, based on how a data pod is being used within software. This provides transparency on data pod's technical data source and its usage within any of the software's analytical modules.

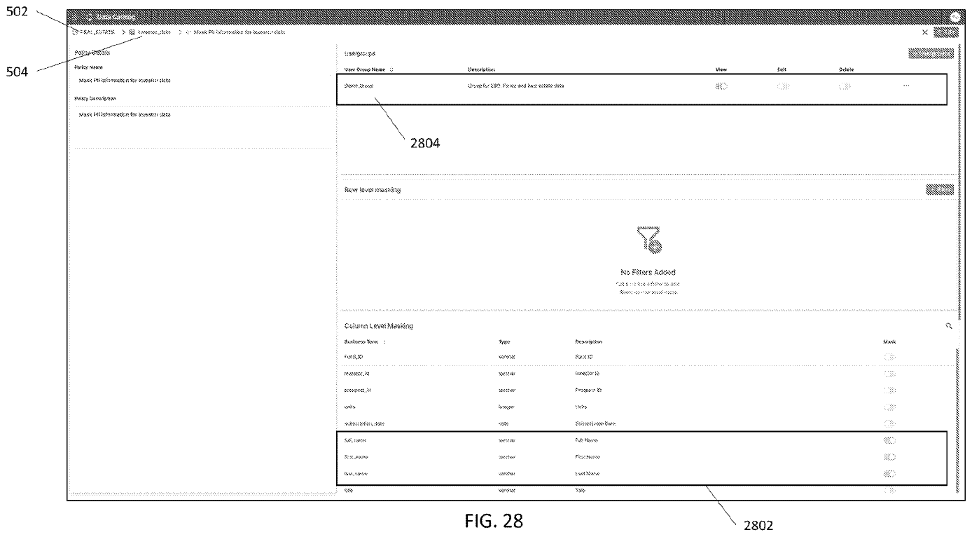

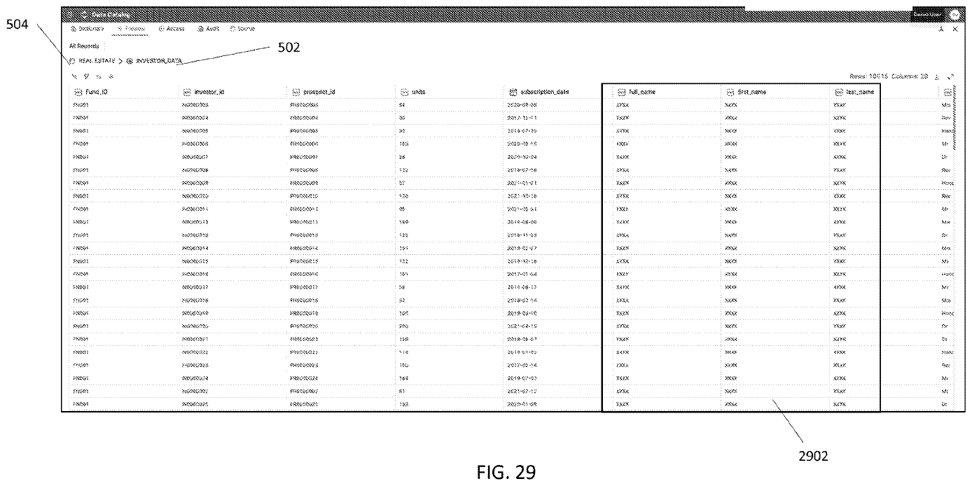

FIGS. 28-29 illustrate an example graphical representations in connection with “Access” options 606 for a Data POD 504 “investor_data,” for data domain 502 “REAL_ESTATE” and includes options for access control policy details (a policy name and description), and data column/field masking options, e.g., in connection with respective business terms. Masking enables the ability to hide or preclude certain values or data elements from being provided to specific user groups. In this way, the present disclosure provides complex techniques for securing information across the enterprise to protect sensitive information or to facilitate organizational role-based data access. In the example shown in FIG. 28, option 2802 is masking “Personal Identifying Information (PII)” from a specific user group 2804 “Demo_Group.” As illustrated in the example display screen shown in FIG. 29, data group 2902 precludes protected or masked information from being shown for a user belonging to a user group 2804, for example, for which an access policy has been defined. Accordingly, such information is not displayed.

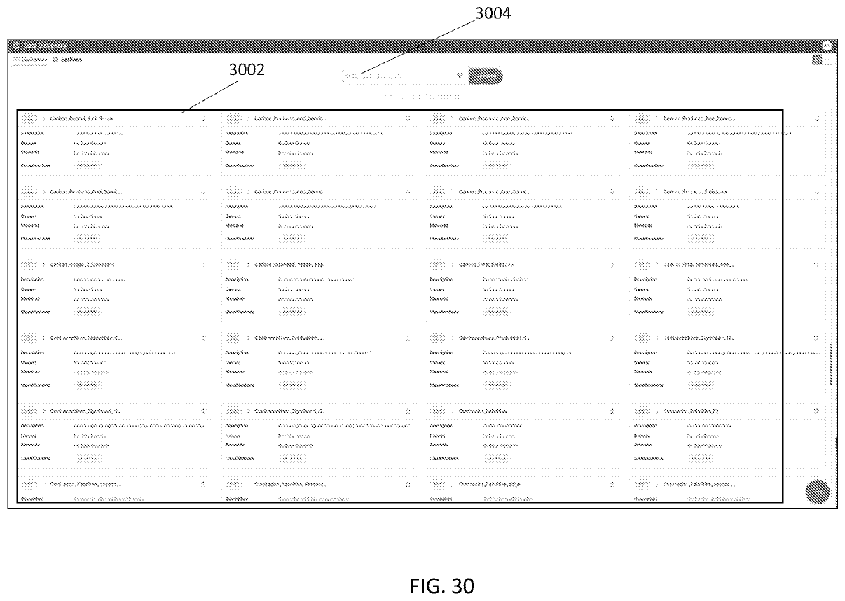

FIG. 30 illustrates an example display screen, including a data dictionary module 3002, which can include a meta-data repository of business data categories, and associated business data terms with additional details. Additional details can include description, data owner, data steward and classifications. Data dictionary module 3002 can provide business meaning and purpose of the data stored in multiple technical systems.

Authorized users can register new data terms through data dictionary module 3002 or while publishing a new data pod through the schema option 2602 (FIG. 26) of a data catalog. Also as illustrated in FIG. 30, search option 3004 is provided for a user to locate information associated with respective data and data pods.

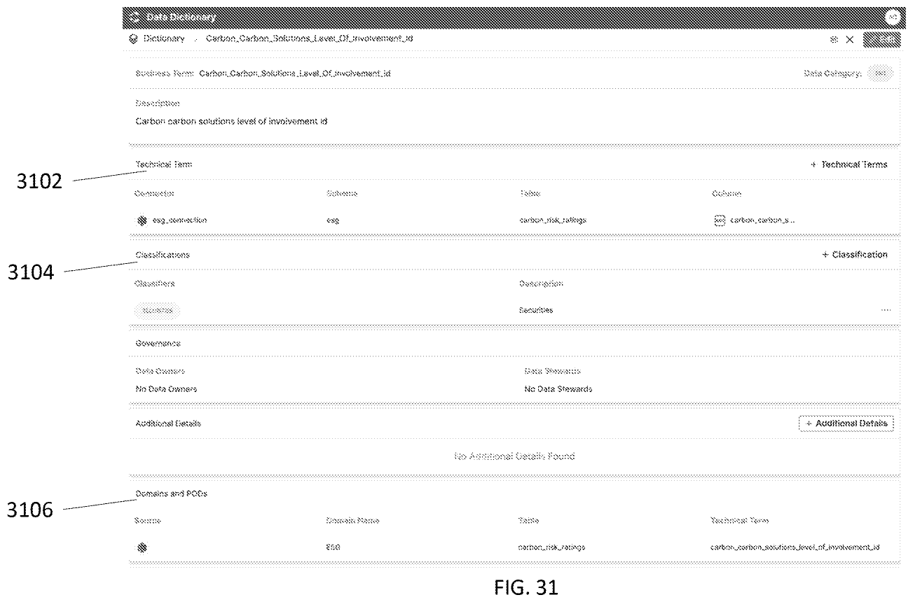

FIG. 31 illustrates an example display screen showing details that can be associated with a data (e.g., business terms) associated with a respective data dictionary. Option 3102 shows one or more technical system details where the data associated with the selected Business Term are stored. Option 3104 provides the flexibility to Classify the Business Terms with one or more “Classifiers”. Classifiers are used to auto-classify the Business Terms based on the content of information stored against that Business Term. Examples of Classifiers include either standard Classifiers for Name, Gender, Social Security #, Credit Card #or industry specific custom identifiers such as Patient ID for an Healthcare Company or Customer ID for a Retail company. Option 3106 shows the Data Domains 502 and Data PODs 504 that include the specific Business Term in the dataset. Hence, Data Dictionary provides a master list of all data attributes published through Data Catalog.

In accordance with the features shown and described herein, a system with virtualized data access integrated with flexible self-service data analysis and data workflow automation capabilities can be provided in a seamless, convenient, and secure manner that has been otherwise unavailable.

Additional features and functions associated with the present disclosure can include auto-identification of related data terms and datasets, automatic anomaly detection, and automatic predictive capabilities, with the purpose of making human interaction with data easier. These and other features of the can be implemented at least partially as a function of machine learning and artificial intelligence.

With regard to auto-identification of related data sets, the present disclosure provides the capability to combine published data pods 504, to create custom insights. However, to do so, user needs to be aware of the data elements in each data pod 504. For example, data pods 504 can be related as a function of artificial intelligence in order to identify what is in the data pod 504 and what are attributes of data in the data pod 504 that might be similar with other data pods 504 through a combination of Business Terms and Classifications assigned to different data attributes registered in Data Dictionary. For example, aspects of one customer data set in one respective data pod 504 can be recognized to be the same or similar with aspects of another types of data in another data pod 504. Related data pods 504 can be based on various information types, such as transactions, products, social media data, or the like, and particular contexts can be based on classification scheme. Moreover, clustering based on artificial intelligence, such as clustering logic, can be performed and suggested related data sets can be and then make suggestions. Training processes (e.g., machine learning) can be based, for example, on underlying data. Classification of data can be provided automatically (e.g., machine-recognized), as well as by users, for example to identify client identification, product identification, or other respective values in data pods 504.

In addition, data can be identified, as being PII or sensitive, such as social security number, through Classifiers, option 3104 in Data Dictionary, as a function of machine learning and/or artificial intelligence. In such case, datasets using be related as a function of artificial intelligence and, thereafter, highlighted for the user at the time of insight creation. This can provide an intuitive and convenient way for users to identify data sets related to separate data pods, such as “clients' information,” “employees' information” and “products' information.” Still further, various usage of data can be used as a basis when joining various data pods 504. The present disclosure provides pre-trained classifiers for Personal Identifying Information (PII) such as Name, Country, Gender, Zip Code, Social Security #, Credit Card #. These classifiers are trained using Machine learning and/or artificial intelligence methods such as ‘Named Entity Recognition.’ In addition, custom Classifiers can be created and trained for industry specific data such as Patient ID used by a healthcare company, Customer ID used by a retail company and Company Symbol used by an investment company. These Classifiers leverage a combination of Machine Learning and/or Artificial Intelligence methods such as Regular Expression and Natural Language Processing (NLP). Auto-classification of data further assists the user of the present disclosure to detect the nature of the data stored in different systems and take actions such as protecting the PII information from unintended use, linking multiple technical data points to a common business term and using such information to link datasets for useful insights.

Turning to anomaly detection, the present disclosure provides the capability to monitor data quality, for example, by defining a “Data Quality Rule.” Such rule can be run against a specific dataset to auto-identify data quality issues (e.g., anomalies) in the data using Machine Learning and/or Artificial Intelligence methods. For example, a numerical drift or difference in data structure can be identified. For example, in one case a customer identification is formatted with nine fields, but in other contexts only four are used. In another example, stock prices may be configured for a range of plus or minus 5%, and any value outside of that range is recognized and the data can be flagged. Artificial intelligence processes can view overall variability of data and, in certain contexts, propose revisions or alerts. The present disclosure provides the flexibility to apply Machine Learning and/or Artificial Intelligence methods for such advanced data quality checks through the IDE within its Flows module option 1905 of FIG. 19.

Moreover, the present disclosure supports predictive functionality, including to predict values of a particular data point, which may be based on historical values. In one or more implementations, features of data history and data attributes are examined, and predictions can be fashioned based on probabilities. For example, a prediction can be made regarding when employees are likely to leave a respective company. One or more programming instructions can be executed for machine learning and/or artificial intelligence to account latest environment, growth, changes in environment; and second efforts and behavior. These features, often in combination, are usable for accurate predictions. The present disclosure provides the flexibility to apply machine learning and/or artificial intelligence methods for such advanced data quality checks through the IDE within a flows module option 1905.

Additionally, the present disclosure enables non-technical users, who may not know how to use an IDE, such as for analysis, to submit a ‘Search Term and Criteria’ such as a “Client Name|Company ABC” or “Employee Name|Joe Smith” or “Order ID|O12345,” or to locate relevant datasets that can have information on the searched term. In accordance to one or more implementations of the present disclosure, after a user selects a specific dataset to view data, results are pre-filtered based on criteria the user provides along with the search term.

Building upon these capabilities, one or more implementations of the present disclosure offers additional mechanisms, such as guided or unguided natural language query techniques, which can allow users to submit business questions using natural language, such as, “who are our top 10 clients by revenue?” or “show orders placed by customer A in last three months.” Natural language processing techniques are leveraged and combined with other shown and described herein, including one or more IDEs, custom data definitions, or a virtualization module, including to find and present answers to such questions.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

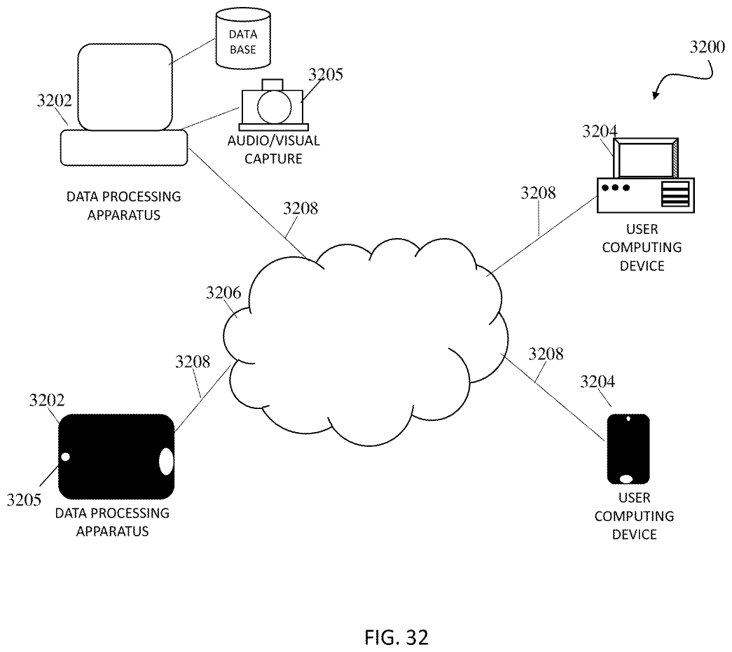

Referring to FIG. 32 a diagram is provided of an example hardware arrangement that operates for providing the systems and methods disclosed herein, and designated generally as system 3200. System 3200 can include one or more data processing apparatuses 3202 that are at least communicatively coupled to one or more user computing devices 3204 across communication network 3206. Data processing apparatuses 3202 and user computing devices 3204 can include, for example, mobile computing devices such as tablet computing devices, smartphones, personal digital assistants or the like, as well as laptop computers and/or desktop computers, server computers, large-scale storage systems, and mainframe computers. Further, one computing device may be configured as a data processing apparatus 3202 and a user computing device 3204, depending upon operations be executed at a particular time. In addition, an audio/visual capture device 3205 is depicted in FIG. 32, which can be configured with one or more cameras (e.g., front-facing and rear-facing cameras), a microphone, a microprocessor, and a communications module(s) and that is coupled to data processing apparatus 3202. The audio/visual capture device 3205 can be configured to interface with one or more data processing apparatuses 3202.

With continued reference to FIG. 32, data processing apparatus 3202 can be configured to access one or more databases for the present disclosure, including database files, spreadsheet files, image files, video content, documents, metadata, and other information. In addition, data processing apparatus 3202 can be configured to access Internet websites and other online content. It is contemplated that data processing apparatus 3202 can access any required databases via communication network 3206 or any other communication network to which data processing apparatus 3202 has access. Data processing apparatus 3202 can communicate with devices including those that comprise databases, using any known communication method, including Ethernet, direct serial, parallel, universal serial bus (“USB”) interface, and/or via a local or wide area network.

User computing devices 3204 communicate with data processing apparatuses 3202 using data connections 3208, which are respectively coupled to communication network 3206. Communication network 3206 can be any communication network, but is typically the Internet or some other global computer network. Data connections 2508 can be any known arrangement for accessing communication network 3206, such as the public internet, private Internet (e.g., VPN), dedicated Internet connection, or dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 3204 preferably have the ability to send and receive data across communication network 3206, and are equipped with web browsers, software applications, or other software and/or hardware tools, to provide received data on audio/visual devices incorporated therewith. By way of example, user computing device 3204 may be personal computers such as Intel Pentium-class and Intel Core-class computers or Apple Macintosh computers, tablets, smartphones, but are not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 3206, and that wireless communication can be provided between wireless devices and data processing apparatuses 3202. In one or more implementations, the present disclosure provides improved processing techniques to prevent packet loss, to improve handling interruptions in communications, and other issues associated with wireless technology.

According to an embodiment of the present disclosure, user computing device 3204 provides user access to data processing apparatus 3202 for the purpose of receiving and providing information. Examples and description of specific functionality provided by system 3200, and in particular data processing apparatuses 3202, is described in detail below.

System 3200 preferably includes software that provides functionality described in greater detail herein, and preferably resides on one or more data processing apparatuses 3202 and/or user computing devices 3204. One of the functions performed by data processing apparatus 3202 is that of operating as a web server and/or a web site host. Data processing apparatuses 3202 typically communicate with communication network 3206 across a permanent i.e., un-switched data connection 3208. Permanent connectivity ensures that access to data processing apparatuses 3202 is always available.

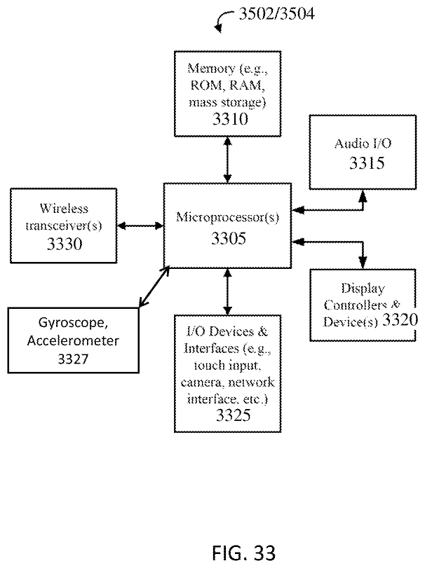

FIG. 33 illustrates, in block diagram form, an exemplary data processing apparatus 3202 and/or user computing device 3204 that can provide functionality in accordance with the teachings herein. Although not expressly indicated, one or more features shown and described with reference to FIG. 33 can be included with or in the audio/visual capture device 3205, as well. Data processing apparatus 3202 and/or user computing device 3204 may include one or more microprocessors 3305 and connected system components (e.g., multiple connected chips) or the data processing apparatus 3202 and/or user computing device 3204 may be a system on a chip.

The data processing apparatus 3202 and/or user computing device 3204 includes memory 3310 which is coupled to the microprocessor(s) 3305. The memory 3310 may be used for storing data, metadata, and programs for execution by the microprocessor(s) 3305. The memory 3310 may include one or more of volatile and non-volatile memories, such as Random Access Memory (“RAM”), Read Only Memory (“ROM”), Flash, Phase Change Memory (“PCM”), or other type of memory.

The data processing apparatus 3202 and/or user computing device 3204 also includes an audio input/output subsystem 3315 which may include a microphone and/or a speaker for, for example, playing back music, providing telephone or voice/video chat functionality through the speaker and microphone, etc.

A display controller and display device 3320 provides a visual user interface for the user; this user interface may include a graphical user interface which, for example, is similar to that shown on a Macintosh computer when running Mac OS operating system software or an iPad, iPhone, or similar device when running mobile computing device operating system software.

The data processing apparatus 3202 and/or user computing device 3204 also includes one or more wireless transceivers 3330, such as an IEEE 802.11 transceiver, an infrared transceiver, a Bluetooth transceiver, a wireless cellular telephony transceiver (e.g., 1G, 2G, 3G, 4G, 5G), or another wireless protocol to connect the data processing system 3200 with another device, external component, or a network. In addition, Gyroscope/Accelerometer 3327 can be provided.

It will be appreciated that one or more buses, may be used to interconnect the various modules in the block diagram shown in FIG. 33.

The data processing apparatus 3202 and/or user computing device 3204 may be a personal computer, tablet-style device, such as an iPad, a personal digital assistant (PDA), a cellular telephone with PDA-like functionality, such as an iPhone, a Wi-Fi based telephone, a handheld computer which includes a cellular telephone, a media player, such as an iPod, an entertainment system, such as a iPod touch, or devices which combine aspects or functions of these devices, such as a media player combined with a PDA and a cellular telephone in one device. In other embodiments, the data processing apparatus 3202 and/or user computing device 3204 may be a network computer or an embedded processing apparatus within another device or consumer electronic product.

The data processing apparatus 3202 and/or user computing device 3204 also includes one or more input or output (“I/O”) devices and interfaces 3325 which are provided to allow a user to provide input to, receive output from, and otherwise transfer data to and from the system. These I/O devices may include a mouse, keypad or a keyboard, a touch panel or a multi-touch input panel, camera, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the data processing apparatus 3202 and/or user computing device 3204. The I/O devices and interfaces 3325 may include a connector for a dock or a connector for a USB interface, Fire Wire, etc. to connect the system 3200 with another device, external component, or a network.

Moreover, the I/O devices and interfaces can include gyroscope and/or accelerometer 3327, which can be configured to detect 3-axis angular acceleration around the X, Y and Z axes, enabling precise calculation, for example, of yaw, pitch, and roll. The gyroscope and/or accelerometer 3327 can be configured as a sensor that detects acceleration, shake, vibration shock, or fall of a device 3202/3204, for example, by detecting linear acceleration along one of three axes (X, Y and Z). The gyroscope can work in conjunction with the accelerometer, to provide detailed and precise information about the device's axial movement in space. More particularly, the 3 axes of the gyroscope combined with the 3 axes of the accelerometer enable the device to recognize approximately how far, fast, and in which direction it has moved to generate telemetry information associated therewith, and that is processed to generate coordinated presentations, such as shown and described herein.

It will be appreciated that additional components, not shown, may also be part of the data processing apparatus 3202 and/or user computing device 3204, and, in certain embodiments, fewer components than that shown in FIG. 33 may also be used in data processing apparatus 3202 and/or user computing device 3204. It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 3310 or other machine-readable storage medium. The software may further be transmitted or received over a network (not shown) via a network interface device 3325. In various embodiments, hardwired circuitry may be used in combination with the software instructions to implement the present embodiments. Thus, the techniques are not limited to any specific combination of hardware circuitry and software, or to any particular source for the instructions executed by the data processing apparatus 3202 and/or user computing device 3204.

Thus, as shown and described herein, the present disclosure provides for user access and use of data that are not copied or moved from locations where the data are otherwise stored and managed. Instead, data are left undisturbed and published, managed, and used via a single business access layer to provide an interactive and widespread virtualized data access.

While operations shown and described herein may be in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this disclosure, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A computer-implemented system for data access, integration, management, and presentation, including at least one data processing apparatus that is configured by executing instructions stored on processor readable media to provide:
a connection module that connects a computing device to each of a plurality of data sources;
at least one first graphical user interface accessible to the computing device, the at least one first graphical user interface displaying information associated with each of the plurality of data sources and providing selectable controls for defining a domain and custom data definitions based on at least some of the plurality of data sources, and for restricting access to at least some data in the at least some of the plurality of data sources;
a virtualization module providing the domain and corresponding virtual datasets of data from the at least some of the data sources in accordance with each of the custom data definitions, without copying or moving data from any of the plurality of data sources;
at least one second graphical user interface accessible to each of a plurality of computing devices, the at least one second graphical user interface providing an integrated development environment including selectable controls for providing, in an altered format, at least one of the virtual datasets in accordance with at least one of the custom data definitions associated with the domain, and
and at least one third graphical user interface accessible to each of a plurality of computing devices, the at least one third graphical user interface presenting the at least one of the virtual datasets in at least one graphical format.

2. The computer-implemented system of claim 1, wherein at least one of the at least one second graphical user interface and the at least one third graphical user interface includes a dashboard.

3. The computer-implemented system of claim 1, wherein the integrated development environment includes controls for defining queries including selections and joins.

4. The computer-implemented system of claim 1, wherein at least one of the at least one first graphical user interface, the virtualization module, and the at least one second graphical user interface provide data security and logging of user activity.

5. The computer-implemented system of claim 1, wherein at least one of the connection module and the virtualization module provide performance optimization.

6. The computer-implement system of claim 1, wherein the performance optimization includes at least one of time, computer resources, and labor.

7. The computer-implemented system of claim 1, further comprising an alert module for defining custom alerts, wherein at least one of the custom alerts is provided in at least one of the second graphical user interface and the at least one third graphical user interface.

8. The computer-implemented system of claim 1, wherein at least one of the connection module and the virtualization module publishes the datasets and monitors data quality, business activity, and data-related events associated with the published datasets.

9. The computer-implemented system of claim 1, wherein at least two of the at least one first graphical user interface, the at least one second graphical user interface, and the at least one third graphical user interface comprise a single graphical user interface.

10. The computing-implemented system of claim 1, wherein the integrated development environment is configured to create at least one new data set from the virtual datasets associated with the domain.

11. The computing-implemented system of claim 10, wherein the at least one third graphical user interface presents the virtual datasets and the at least one new data set in at least one graphical format.

12. The computing-implemented system of claim 1, further comprising at least one fourth graphical user interface accessible to each of a plurality of computing devices, wherein the at least one fourth graphical user interface provides searching functionality.

13. The computing-implemented system of claim 1, wherein the virtualization module includes a meta-data definition layer.

14. A computer-implemented method for data access, integration, management, and presentation, the method comprising:
connecting, via a connection module provided by at least one data processing apparatus that is configured by executing instructions stored on processor readable media, a computing device to each of a plurality of data sources;
displaying, by the at least one data processing apparatus via at least one first graphical user interface that is accessible to the computing device, information associated with each of the plurality of data sources and providing selectable controls for defining a domain and associates custom data definitions based on at least some of the plurality of data sources, and for restricting access to at least some data in the at least some of the plurality of data sources;
providing, by the at least one data processing apparatus via a virtualization module, the domain and corresponding virtual datasets of data from the at least some of the data sources in accordance with each of the custom data definitions, without copying or moving data from any of the plurality of data sources;
providing, by the at least one data processing apparatus via at least one second graphical user interface accessible to each of a plurality of computing devices, an integrated development environment including selectable controls for providing access to at least one of to-the virtual datasets associated with the domain, and
presenting, by the at least one data processing apparatus via at least one third graphical user interface accessible to each of a plurality of computing devices, the at least one of the virtual datasets in at least one graphical format.

15. The computer-implemented method of claim 14, wherein at least one of the at least one second graphical user interface and the at least one third graphical user interface includes a dashboard.

16. The computer-implemented method of claim 14, wherein the integrated development environment includes controls for defining queries including selections and joins.

17. The computer-implemented method of claim 14, wherein at least one of the at least one first graphical user interface, the virtualization module, and the at least one second graphical user interface provide data security and logging of user activity.

18. The computer-implemented method of claim 14, wherein at least one of the connection module and the virtualization module provide performance optimization.

19. The computer-implement method of claim 14, wherein the performance optimization includes at least one of time, computer resources, and labor.

20. The computer-implemented method of claim 14, further comprising:
defining, via an alert module, custom alerts, wherein at least one of the custom alerts is provided in at least one of the second graphical user interface and the at least one third graphical user interface.

21. The computer-implemented method of claim 14, wherein at least one of the connection module and the virtualization module publishes the datasets and monitors data quality, business activity, and data-related events associated with the published datasets.

22. The computer-implemented method of claim 14, wherein at least two of the at least one first graphical user interface, the at least one second graphical user interface, and the at least one third graphical user interface comprise a single graphical user interface.

23. The computing-implemented method of claim 14, wherein the integrated development environment is configured to create at least one new data set from the virtual datasets associated with the domain.

24. The computing-implemented method of claim 23, wherein the at least one third graphical user interface presents the virtual datasets and the at least one new data set in at least one graphical format.

25. The computing-implemented method of claim 14, further comprising:
providing, by the at least one data processing apparatus via at least one fourth graphical user interface that is accessible to each of a plurality of computing devices, searching functionality.

26. The computing-implemented method of claim 14, wherein the virtualization module includes a meta-data definition layer.

27. The computer-implemented system of claim 1, wherein the at least one data processing apparatus is further configured by executing instructions stored on processor readable media to:
generate an altered format representing the at least one of the virtual datasets,
wherein the at least one graphical format is based on a selection of the altered format by at least one of the plurality of computing devices.

28. The computer-implemented method of claim 14, further comprising:
generating, by the at least one data processing apparatus, an altered format representing the at least one of the virtual datasets, and
wherein the at least one graphical format is based on a selection of the altered format by at least one of the plurality of computing devices.
